(19) United States
(12) Patent Application Publication
(10) Pub. No.: US 2026/0147881 A1
(43) Pub. Date: May 28, 2026

(54) Anomaly Detection and Resolution Using Artificial Intelligence

(71) Applicant: Bank of America Corporation, Charlotte, NC (US)

(72) Inventors: Aaron Gee, Palm Coast, FL (US); Manonmani Palanichamy, Fort Mill, SC (US); Amer Ali, Jersey City, NJ (US); Saleem Gaziani, Plano, TX (US); Aisha Jenkins, Atlanta, GA (US); John Andres Lozes, Wilmington, DE (US); Tonya Kyra Miller, Charlotte, NC (US); Asha Thekkumpurath, Frisco, TX (US); Andrea M. Weisberger, Jacksonville, FL (US); Aravind Singtalur, McKinney, TX (US)

(21) Appl. No.: 18/961,632

(22) Filed: Nov. 27, 2024

(51) Int. Cl. G06F 21/55; G06N 20/00

(52) U.S. Cl. CPC G06F 21/554; G06N 20/00; G06F 2221/034

(57) ABSTRACT

Arrangements for detecting and resolving anomalies are provided. A computing platform may train an artificial intelligence (AI) engine. The computing platform may configure one or more anomaly detection rules and deploy the one or more anomaly detection rules. The computing platform may receive an encrypted screenshot. The computing platform may decrypt the encrypted screenshot. The computing platform may input the decrypted screenshot into the AI engine. The computing platform may output, based on analyzing the decrypted screenshot using the AI engine, an action to resolve an identified anomaly. The computing platform may execute the action to resolve the identified anomaly.

### BACKGROUND

In some instances, anomalies may result from a user accessing an application on a web browser that is hosted at a back-end server system. Currently, the detection of anomalies related to the operation of the hosted application may be time consuming and require excess computing resources. Further, security issues may be introduced when the host of the application is transferred from one server to another server. Accordingly, it may be advantageous to identify more improved methods and systems for detecting and resolving such anomalies.

### SUMMARY

Aspects of the disclosure provide effective, efficient, scalable, and convenient solutions that address and overcome the technical problems associated with automatically detecting and protecting a network from an email deluge. In accordance with one or more aspects, a computing platform with at least one processor, a communication interface communicatively coupled to the at least one processor, and memory storing computer-readable instructions may train, based on historical screenshots, an artificial intelligence (AI) engine, in which the training may configure the AI engine to output an executable action to resolve an anomaly within an application session. The computing platform may configure one or more anomaly detection rules. The computing platform may deploy the one or more anomaly detection rules to a user device, where deploying the one or more anomaly detection rules may configure the user device to enforce the one or more anomaly detection rules locally, and where the user device may establish a first application session with a first application server via a web browser. The computing platform may receive, based on the user device detecting a first anomaly using the one or more anomaly detection rules that were deployed by the computing platform, an encrypted screenshot from the user device. The computing platform may decrypt the encrypted screenshot. The computing platform may input the decrypted screenshot into the AI engine. The computing platform may output, based on analyzing the decrypted screenshot using the AI engine, an action to resolve the first anomaly. The computing platform may execute the action, in which the executing may include sending commands that resolve the first anomaly.

In some instances, the one or more anomaly detection rules may further include a first rule based on the user device detecting a missing heartbeat from an application server that may be hosting the first application session that the user device may access via a web browser, a second rule based on detecting a different internet protocol (IP) address than an expected IP address, and a third rule based on detecting an application rendering error.

In one or more examples, the one or more anomaly rules may be categorized into one or more anomaly categories, in which a first anomaly category may be based on a site switch, and where the first rule may correspond to the first anomaly category, a second anomaly category that may be based on a session hijacking attempt, where the second rule may correspond to the second anomaly category, and a third anomaly category that may be based on an application error, where the third rule may correspond to the third anomaly category.

In some instances, a first action may be based on the first anomaly category, and the first action may include generating instructions based on the analyzing the decrypted screenshot using the AI engine and sending, to a second application server, the instructions, that when received by a second application server, may cause the second application server to re-create the first application session of the first application server.

In one or more examples, a second action may be based on the second anomaly category, and the second action may include disconnecting a session hijacking device from the user device and blocking an internet protocol (IP) address associated with the session hijacking device to block the session hijacking device from a subsequent connection to the user device.

In some instances, a third action may be based on the second anomaly category, and the third action may include identifying a proper team to further analyze the first anomaly, and sending an alert to the proper team.

In one or more examples, training the AI engine may further include training the AI engine to analyze the historical screenshots using a natural language processing algorithm or an optical character recognition (OCR) algorithm. In some instances, the computing platform may update, using a dynamic feedback loop and based on the inputting, the outputting, and the executing, the AI engine.

In one or more examples, the computing platform may generate a report, in which the report may include the first anomaly and the action that was executed. In some instances, the computing platform may send, to an enterprise administrative device, the report and one or more commands directing the enterprise administrative device to display the report, which may cause the enterprise administrative device to display the report.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for detecting and resolving anomalies using AI in accordance with one or more example aspects described herein;

FIGS. 2A-2F depicts an illustrative event sequence for detecting and resolving anomalies using AI in accordance with one or more aspects described herein;

FIG. 3 depicts an illustrative method for detecting and resolving anomalies using AI in accordance with one or more aspects described herein;

FIG. 4 depicts an illustrative screenshot for detecting and resolving anomalies using AI in accordance with one or more aspects described herein;

FIGS. 5A-5B depict illustrative graphical user interfaces for detecting and resolving anomalies using AI in accordance with one or more aspects described herein;

FIG. 6 depicts an illustrative computing environment for implementing a worst-case scenario failover in accordance with one or more aspects described herein; and

FIG. 7 is a flowchart illustrating an example method of implementing a worst-case scenario failover in accordance with one or more aspects described herein.

### DETAILED DESCRIPTION

In the following description of various illustrative aspects, reference is made to the accompanying drawings, which form a part hereof, and in which is shown, by way of illustration, various aspects of the disclosure may be practiced. In some instances, other aspects may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction, one or more aspects of the disclosure relate to detecting and resolving anomalies using artificial intelligence (AI). Currently, moving between sites and/or availability zones might not always be transparent and seamless. During a failure or failover, even though a user may still have a valid session that is hosted on, for example, an application server, the user may lose their current progress during an application session or the user may be auto-logged out. Currently, users may need to re-login or to navigate back to where they were in an on-line (through, e.g., a web browser) application and subsequently re-input information to get to the point they were at prior to the failover event. During an event like this, security issues associated with session hijacking may be higher due to the disconnect between the original application server end point and the new application server end point.

Accordingly, described herein is a system that leverages application heartbeat/keep-alive technology and AI analysis of an encrypted screenshot and page data (e.g., metadata) to determine where the user was in the application (i.e., progress in a given application session, or the like) and subsequently re-establish a proper application session to allow the user to continue their work seamlessly. This system may also be leveraged to detect sophisticated session hijacking attacks.

In some instances, an online application may send a heartbeat/keep-alive back to one or more application servers for security purposes. Once a heartbeat/keepalive is missed or the user receives a cookie that informs the application that the user is leaving the current site/availability zone, an application screenshot may be taken and incorporated with current application state (raw HTML, headers, cookies, etc). Then, the screenshot may be encrypted, and saved on the user's local device. Subsequently, the screenshot and data may be sent and analyzed using AI to determine exactly where the user was before the session was restarted and additionally ensure the session is valid. This allows the application to reset to the exact moment the connectivity changed, thereby providing a seamless failover experience with minimal disruption. If the AI analysis of the session data or screenshot determines that the session has been hijacked, the user may be logged out and an alert may be generated.

Accordingly, the screenshot may be auto-deleted after the session is re-established or after a timeout. Additionally, the system may leverage information, such as calls and/or cookies that may already be in place to determine application state information and when a screenshot needs to be taken. In some instances, the system may utilize encryption and time-to-live (TTL) to prevent information leakage.

Accordingly, the AI engine may use natural language processing (NLP) algorithms, optical character recognition (OCR) logic, and/or OCR algorithms to interpret the screenshot and application state data to determine exactly where the user is in the application or if the session was hijacked.

Accordingly, the system may utilize technology that allows mimicking user inputs to re-create the exact application state prior to user moving between datacenters/availability zones.

These and other features are described in further detail below.

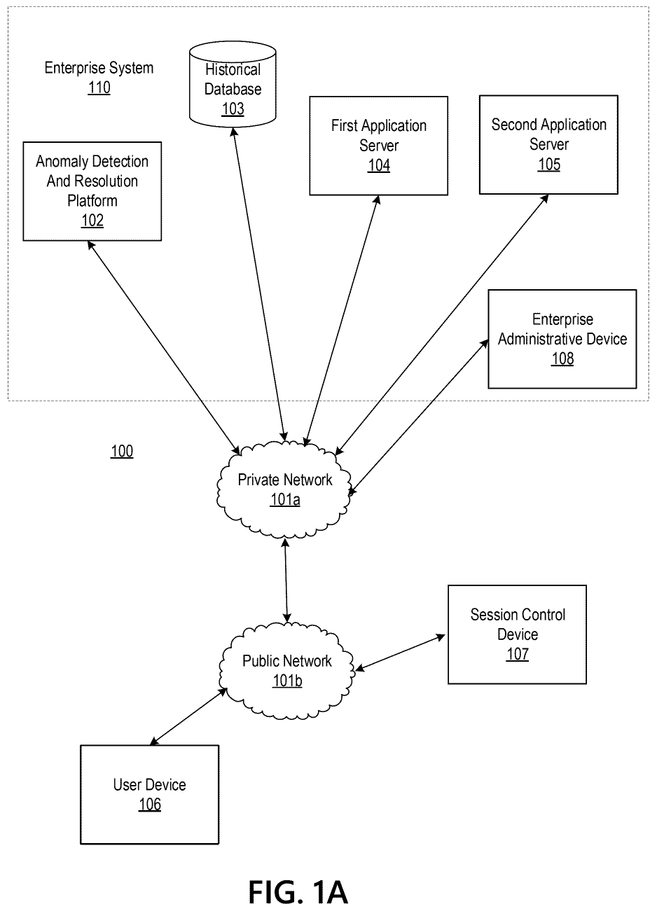

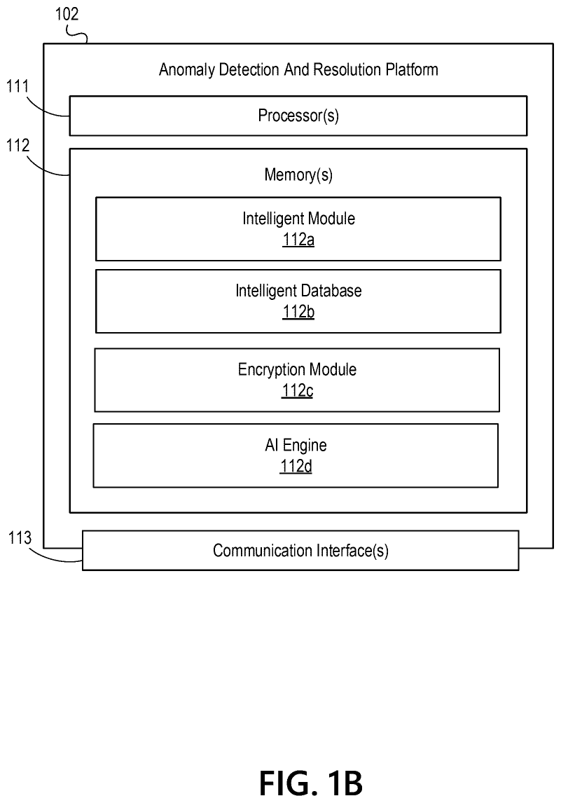

FIGS. 1A-1B depict an illustrative computing environment for detecting and resolving anomalies using AI in accordance with one or more example aspects described herein. Referring to FIG. 1A, computing environment 100 may include one or more computer systems connected through one or more networks. For example, computing environment 100 may include anomaly detection and resolution platform 102, historical database 103, first application server 104, second application server 105, user device 106, session control device 107, and enterprise administrative device 108. While the illustration of FIG. 1A includes particular numbers of devices, any number of systems or devices may be used without departing from the aspects described herein.

As mentioned above, computing environment 100 also may include one or more networks, which may interconnect one or more of anomaly detection and resolution platform 102, historical database 103, first application server 104, second application server 105, user device 106, session control device 107, and/or enterprise administrative device 108. For example, computing environment 100 may include private network 101a and public network 101b. In some instances, private network 101a and/or public network 101b may include one or more sub-networks (e.g., Local Area Networks (LANs), Wide Area Networks (WANs), or the like). In some instances, private network 101a may be associated with a particular user, location (e.g., home, office), and/or organization (e.g., a corporation, financial institution, educational institution, governmental institution, or the like), and may interconnect one or more computing devices associated with the user, location and/or organization.

According to one or more aspects, one or more devices within the private network 101a may form a sub-network (e.g., enterprise system 110). In FIG. 1A, for example, anomaly detection and resolution platform 102, historical database 103, first application server 104, second application server 105, and/or enterprise administrative device 108 may collectively form a sub-network of devices. Although not shown, user device 106 may additionally or alternatively be part of enterprise system 110 and connect to private network 101a without departing from the scope of the disclosure. For example, enterprise system 110 may be a sub-network that represents an organization (e.g., a corporation, financial institution, educational institution, governmental institution, or the like). Devices in enterprise system 110 may communicate with one another using private network 101a and/or public network 101b.

As described further below, anomaly detection and resolution platform 102, may be a computer system that includes one or more computing devices (e.g., servers, server blades, or the like) and/or other computer components (e.g., processors, memories, communication interfaces) that may be used to train, host, and/or otherwise refine an artificial intelligence (AI) engine, which may be used to detect anomalies associated with a user accessing an application using a web browser that is hosted on an application server (e.g., first application server 104), analyze a screenshot and identify an action to resolve the anomaly based on analyzing the screenshot, execute the identified action, and/or perform other functions.

Historical database 103 may include one or more computing devices and/or other computer components (e.g., processors, memories, communication interfaces). In some instances, historical database 103 may include one or more data sources that may store historical screenshots, which may be used by anomaly detection and resolution platform 102, in furtherance of training the AI engine. In some instances, historical database 103 may be configured as a cloud storage system, in which historical database 103 may be a cloud computing model that stores information on the Internet through a cloud computing provider who manages and operates historical database 103 as a service. In some instances, historical database 103 may be local or non-cloud based storage, or may support cloud based storage.

First application server 104 and/or second application server 105 may be a computer system that includes one or more computing devices (e.g., servers, server blades, or the like) and/or other computer components (e.g., processors, memories, communication interfaces) that may be used to host an application that user device 106 may access via a web browser, send a heartbeat or cookie to a user device 106, receive session information from anomaly detection and resolution platform 102, establish a new application session based on information (e.g., instructions) from anomaly detection and resolution platform 102, and/or perform other functions. In some instances, each of first application server 104 and/or second application server 105 may represent a data center in a particular geographic location. Additionally or alternatively, first application server 104 and second application server 105 may together form a data center. Although only first application server 104 and second application server 105 are shown, fewer or additional application servers may be utilized without departing from the scope of the disclosure.

User device 106 may be a laptop computer, desktop computer, mobile device, tablet, smartphone, and/or other device, which may represent, for example, a user outside of enterprise system 110 (or in some cases, and although not shown, within enterprise system 110). In some instances, user device 106 may be a user computing device that is used by an individual. In some instances, user device 106 may be configured to receive, from anomaly detection and resolution platform 102, one or more anomaly detection rules, that when deployed at user device 106, cause user device 106 to capture a screenshot corresponding to an application session, encrypt the screenshot, and send the screenshot to anomaly detection and resolution platform 102 to be analyzed by an AI engine, and/or perform other functions.

Session control device 107 may be one or more computing devices associated with an individual or entity that is currently operating outside of private network 101a. In some instances, session control device 107 may be a source of a session hijacking attempt, and may connect user device 106 via the public network 101b (without user device 106 knowing that session control device 107 is pretending to be an applicant server, such as either of first application server 104 or second application server 105). In some instances, session control device 107 may be one or more devices that may be represent one or more malicious actors that may attempt to control an application session that user device 106 may be accessing, in order to hack and/or otherwise gain access to private information associated with user device 106.

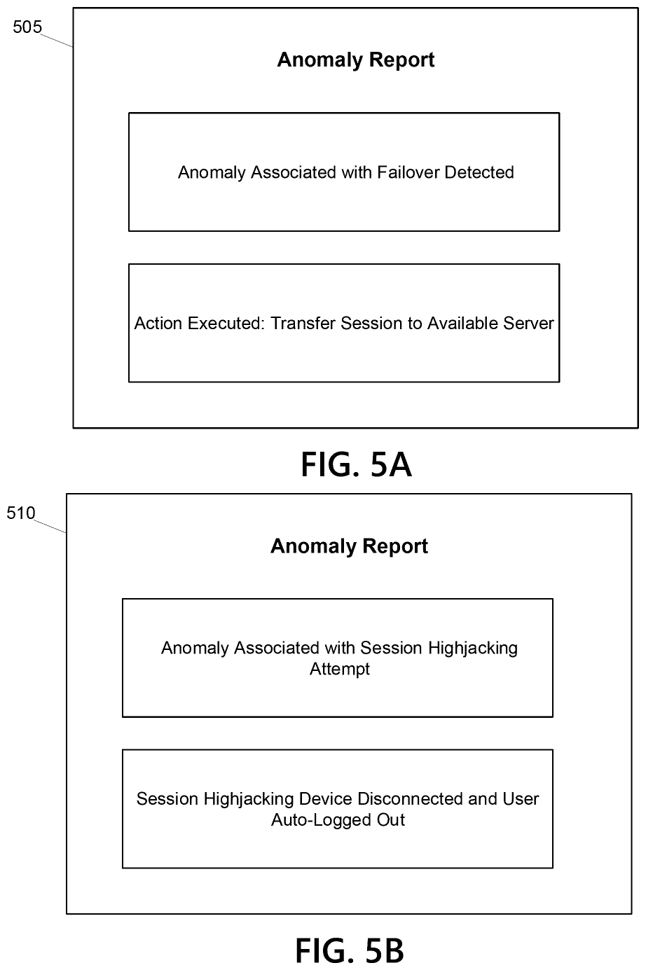

Enterprise administrative device 108 may be a laptop computer, desktop computer, mobile device, tablet, smartphone, and/or other device, which may represent, for example, computing device that is used by an administrator within enterprise system 110. In some instances, enterprise administrative device 108 may be configured to display one or more user interfaces (e.g., interfaces depicting an anomaly report, such as what is shown by FIGS. 5A and 5B, or the like).

In one or more arrangements, anomaly detection and resolution platform 102, historical database 103, first application server 104, second application server 105, user device 106, session control device 107, enterprise administrative device 108 may be any type of computing device capable of sending and/or receiving requests and processing the requests accordingly. For example, anomaly detection and resolution platform 102, historical database 103, first application server 104, second application server 105, user device 106, session control device 107, enterprise administrative device 108, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of anomaly detection and resolution platform 102, historical database 103, first application server 104, second application server 105, user device 106, session control device 107, enterprise administrative device 108 may, in some instances, be special-purpose computing devices configured to perform specific functions.

Referring to FIG. 1B, anomaly detection and resolution platform 102 may include one or more processors 111, memory 112, and communication interface 113. A data bus may interconnect processor 111, memory 112, and communication interface 113. Communication interface 113 may be a network interface configured to support communication between anomaly detection and resolution platform 102 and one or more networks (e.g., private network 101a, public network 101b, or the like). Memory 112 may include one or more program modules having instructions that when executed by processor 111 cause anomaly detection and resolution platform 102 to perform one or more functions described herein and/or one or more databases that may store and/or otherwise maintain information which may be used by such program modules and/or processor 111. In some instances, the one or more program modules and/or databases may be stored by and/or maintained in different memory units of anomaly detection and resolution platform 102 and/or by different computing devices that may form and/or otherwise make up anomaly detection and resolution platform 102. For example, memory 112 may have, host, store, and/or include intelligent module 112a, intelligent database 112b, encryption module 112c, and/or artificial intelligence (AI) engine 112d.

Intelligent module 112a may have instructions that direct and/or cause anomaly detection and resolution platform 102 to receive historical screenshots, train an AI engine, detect and/or resolve anomalies, and/or perform other functions, as discussed in greater detail below. Intelligent database 112b may store information used by intelligent module 112a and/or anomaly detection and resolution platform 102 in application of advanced techniques to detect and resolve anomalies, and/or in performing other functions. Encryption module 112c may be configured to encrypt and/or decrypt a screenshot that is received from user device 106, and/or perform other functions. AI engine 112d may be used by anomaly detection and resolution platform 102 and/or intelligent module 112a to train, refine and/or otherwise update methods for receiving a screenshot, analyzing the screenshot to identify an action to resolve an identified anomaly, and/or perform other methods described herein.

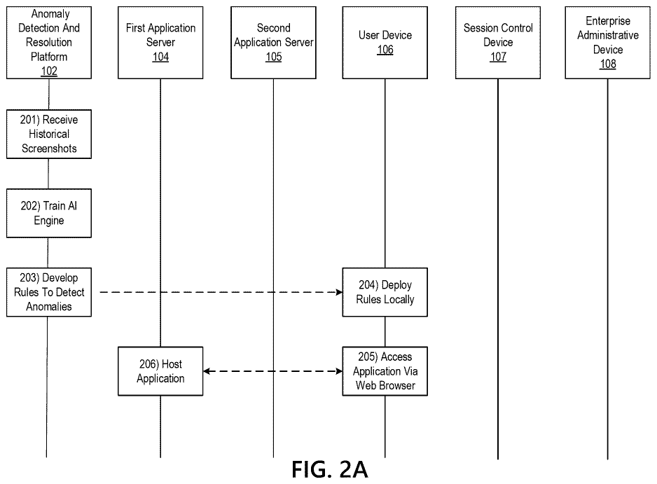

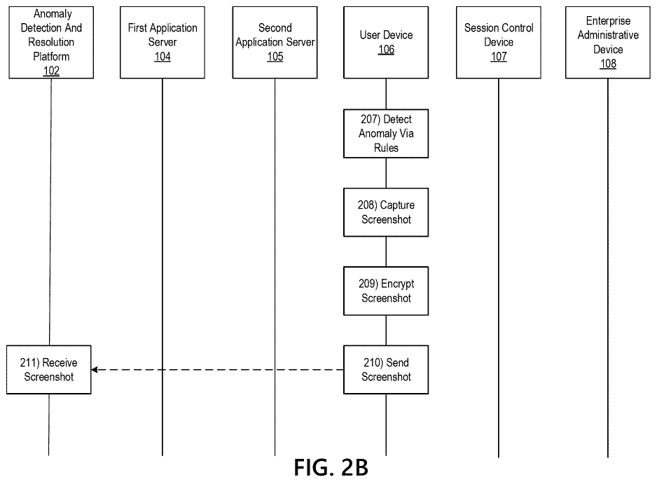

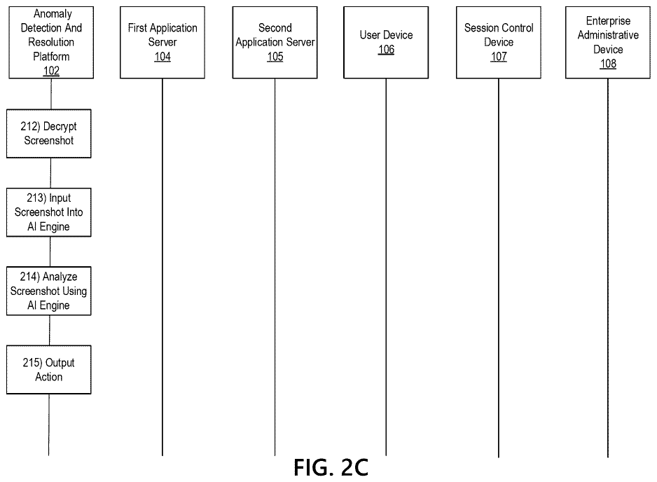

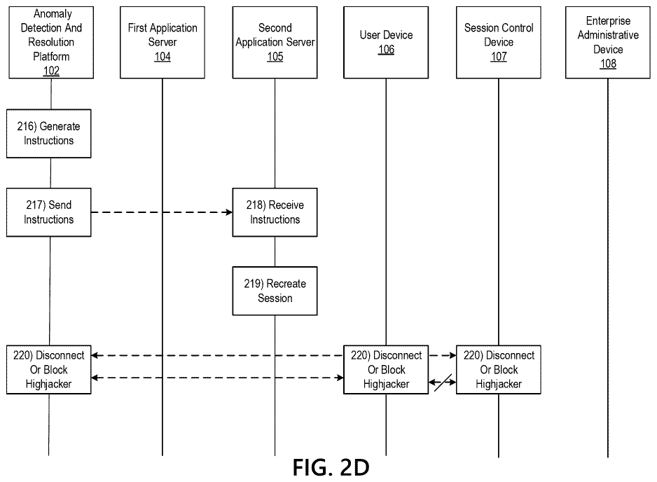

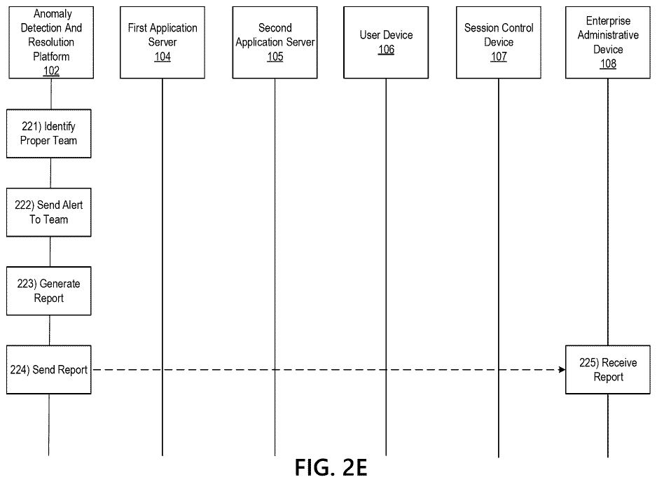

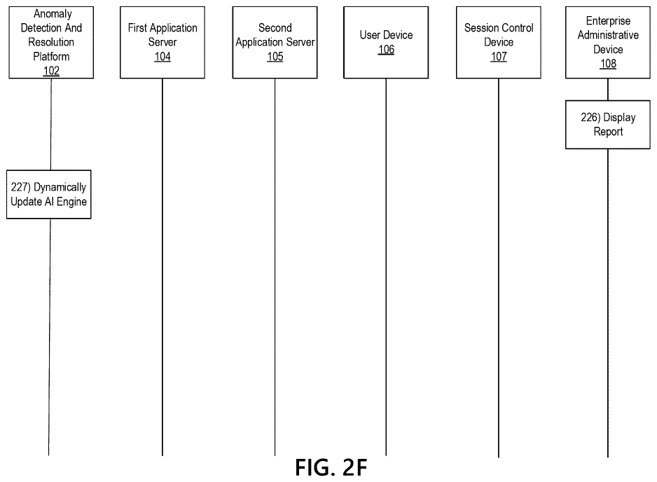

FIGS. 2A-2F depicts an illustrative event sequence for detecting and resolving anomalies using AI in accordance with one or more aspects described herein. Referring to FIG. 2A, at step 201, anomaly detection and resolution platform 102 may receive one or more historical screenshots. For example, anomaly detection and resolution platform 102 may receive the one or more historical screenshots from historical database 103 and via private network 101a.

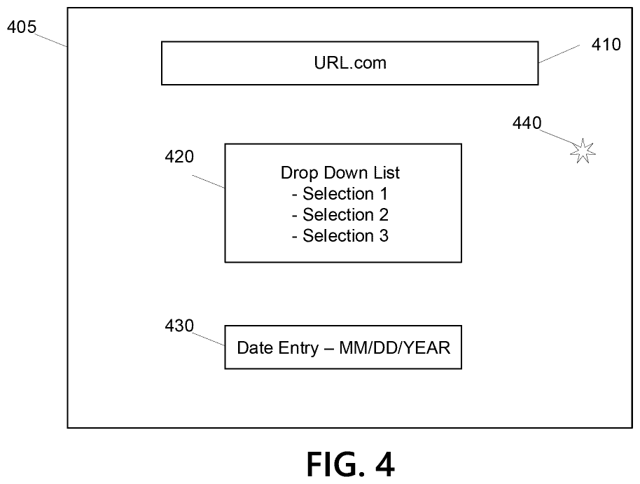

For example, a historical screenshot may be based on a historical application session, and may include visual information related to a current state of the application (e.g., a URL address associated with the application, user selections/entries within the application, or the like, as shown and described in more detail with respect to FIG. 4). Additionally or alternatively, the screenshot may further include metadata associated with the historical application session and/or the historical screenshot, such as HTML information, header information, cookies, etc. As such, information associated with the historical screenshot may be used to train an AI engine, as discussed in more detail at step 202.

At step 202, anomaly detection and resolution platform 102 may train an AI engine (e.g., AI engine 112d) using the historical screenshots that were received at step 201. In some instances, the AI engine may utilize supervised learning, in which labeled datasets may be inputted into to the AI engine, which may be used to train the AI engine to perform the functions described below. For example, supervised learning techniques such as linear regression, classification, neural networking, and/or other supervised learning techniques may be used. Additionally or alternatively, techniques such as natural language processing (NLP) and/or optical character recognition (OCR) may be used to interpret visual and/or linguistic information associated with the one or more historical screenshots.

In training the AI engine, anomaly detection and resolution platform 102 may train the AI engine to analyze a screenshot that is received from user device 106, identify an action to resolve an anomaly associated with the screenshot, and/or execute the identified action. For example, an action may be generating and sending instructions to an application server (e.g., second application server 105), that when received by the application server, may direct the application server to re-create an application session based on the instructions, in which the-re-created application session may correspond to a previous application session that was hosted by a different application server (e.g., application server 104). In this manner, a seamless site switch from one application server to another application server may be achieved, without user device 106 being auto-logged out and required to re-input information to get back to an application that that was previously hosted at the previous/original application server (e.g., first application server 104).

As another example, an action may be, based on identifying that an anomaly corresponds to a session hijacking attempt by session control device 107, disconnect and/or block session control device 107 from user device 106 (which might not know session control device 107 is attempting a session hijack of the application session that user device 106 is accessing via the web browser).

As another example, an action may be, based on identifying that an anomaly corresponds to an application rendering error, identifying a proper team (e.g., a software development team), and sending an alert to the proper team to resolve the anomaly (by, e.g., developing a software update and deploying the software update).

At step 203, anomaly detection and resolution platform 102 may develop one or more rules to detect anomalies. For example, a first rule may be based on detecting a missing heartbeat. A heartbeat may be a cookie or any other similar type of information that may be sent by an application server (e.g., application server 104) to user device 106 on a periodic basis (e.g., once every 30 seconds). If user device 106 detects a missing heartbeat, representing a failover or site switch, that the first rule may be triggered and user device may capture a screenshot, as discussed in more detail with respect to steps 207 and 208.

As another example, a second rule may be based on detecting the presence of a session hijacker, such as detecting an internet protocol (IP) address that is different from an IP address that corresponds to first application server 104. If the second rule is triggered by user device 106, representing the presence of a session hijacker, then in response to the second rule being triggered, user device 106 may capture, encrypt and send a screenshot to anomaly detection and resolution platform 102 for analysis using the AI engine. Although described in reference to an IP address, other information such as a geographic location, a communications protocol (e.g., post office protocol (POP), internet message access protocol (IMAP), simple mail transfer protocol (SMTP), and/or other protocols, a security protocol (e.g., secure sockets layer (SSL), transport layer security (TLS), and/or other protocols), and/or other similar information may be used to create rules that may be used to detect the presence of a session hijacker without departing from the scope of the disclosure.

As another example, a third rule may be based on an application rendering error. If the third rule is triggered by user device 106, then in response, user device 106 may capture, encrypt, and send a screenshot to anomaly detection and resolution platform 102 for analysis using the AI engine.

In some instances, in developing the anomaly detection rules, anomaly detection and resolution platform 102 may develop one or more categories of rules, in which each of the one or more rules may correspond to one of the categories of rules. For example, the previously mentioned first rule may correspond to a failover anomaly category. As another example, the previously mentioned second rule may correspond to a session hijacking category. As another example, the previously mentioned third rule may correspond to an application error category. In this manner, the developed anomaly detection rules may be categorized into one or more anomaly categories, which may be used in furtherance of anomaly detection platform 102 identifying an action to resolve the detected anomaly.

At step 204, anomaly detection and resolution platform 102 may deploy the rules that were developed at step 203 to user device 106. For example, anomaly detection and resolution platform 102 may deploy the anomaly detection rules via the private network 101a and/or the public network 101b, which may, e.g., configure the user device 106 to apply and enforce the anomaly detection rules locally.

At step 205, user device 106 may access an application via a web browser. For example, a user associated with user device 106 may access a web browser, enter information in order to access the desired application (by e.g., entering a URL or website address). In response, first application server 104 may host the application, via the private network 101a and/or the public network 101b. For example, protocols such as hypertext transfer protocol (HTTP) may be used in furtherance of transferring information related to the application between user device 106 and first application server 104. Additionally, one or more layers, such as an application transport layer and/or an internet protocol (IP) layer may be used in furtherance of first application server 104 hosting the application session and/or transferring information related to the hosting of the application session with user device 106.

At step 206, first application server 104 may host the application that was accessed by user device 106 at step 205. For example, the application may correspond to a banking application, in which a user corresponding to user device 106 may desire to apply for a loan or receive other financial information. In some instances, first application server 104 may be identified as a server that contains the information needed for user device 106 to apply for a loan. As such, when user device 106 access the application via a web browser, information related to/necessary for the loan application, which may be stored at first application server 104, may be identified as being the proper application host.

Referring to FIG. 2B, at step 207, user device 106 may detect an anomaly via the one or more anomaly detection rules that were deployed at step 204. For example, user device 106 may detect an anomaly based on the first rule (e.g., a missing heartbeat from first application server 104). As another example, user device 106 may detect an anomaly based on the second rule (e.g., an indication of the presence of a session hijacking attempt). As another example, user device 106 may detect an anomaly based on the third rule (e.g., an application rendering error).

At step 208, user device 106 may capture a screenshot based on detecting the anomaly at step 207. For example, in capturing the screenshot, user device 106 may capture information associated with an application webpage (e.g., what is shown and described with reference to FIG. 4), and/or other information (e.g., metadata) that corresponds to a current application state of the application that user device 106 is accessing via the web browser and hosted at first application server 104. In this manner, user device 106 may capture information that may be subsequently input into and analyzed by the AI engine to output and execute an action corresponding to the detected anomaly (e.g., generate and send instructions to second application server 105 to re-create an application session that corresponds to the application state of the original application session (e.g., the session established at step 205) prior to detection of the anomaly).

At step 209, user device 106 may encrypt the screenshot that was captured at step 208. For example, user device 106 may used encryption methods such as asymmetric encryption (e.g., Rivest-Shamir-Adleman (RSA) encryption), symmetric encryption (advanced encryption standard AES) encryption, or the like).

At step 210, user device 106 may send the encrypted screenshot to anomaly detection and resolution platform 102. For example, user device 106 may send the encrypted screenshot via the private network 101a and/or the public network 101b.

At step 211, anomaly detection and resolution platform 102 may receive the encrypted screenshot. For example, anomaly detection and resolution platform 102 may send the encrypted screenshot via the private network 101a and/or the public network 101b.

Referring to FIG. 2C, at step 212, anomaly detection and resolution platform 102 may decrypt the encrypted screenshot. For example, anomaly detection and resolution platform 102 may use encryption module 112c to decrypt the encrypted screenshot by reversing the encryption method used by user device 106 to encrypt the screenshot. In some instances, encryption module 112c may have been previously configured to identify which encryption method was used by user device 106 in order to identify which decryption process to perform. In decrypting the screenshot, anomaly detection and resolution platform 102 may decrypt information that may be used by the AI engine to analyze the anomaly, identify the type of anomaly that was detected and further identify an action to resolve the anomaly, as discussed in more detail below.

At step 213, anomaly detection and resolution platform 102 may input the decrypted screenshot into the AI engine. At step 214, anomaly detection and resolution platform 102 may analyze the screenshot using the AI engine. For example, a screenshot may be similar to what is shown by screenshot 405. With reference to FIG. 4, screenshot 405 may show URL entry 410, drop down list 420, date entry 430, and hidden icon 440. URL entry 410 may show a website address that may correspond to an application that a user associated with user device 106 may be accessing. Drop down list 420 may be a list of options that a user associated with user device 106 may interactively select, representing, for example, a type of loan a user may be interested in applying for. Date entry 430 may be an entry that a user associated with user device 106 may interactively select in order to input a desired data, associated with, for example, a date in which a user would like to receive a loan. Hidden icon 440 may be an indication not viewable to a user, but machine-readable (by e.g., anomaly detection and resolution platform 102), which may be a way in which the AI engine may detect a session hijacking attempt, as discussed in more detail below.

In some instances, the AI engine may utilize an NLP algorithm to convert words/texts on the screenshot into a machine-readable format (e.g., URL 410, drop down list 420, date entry 430). Additionally or alternatively, the AI engine may use OCR logic to convert visual information displayed by the screenshot (e.g., hidden icon 440) into a machine-readable format. For example, the AI engine may create a grid of the screenshot 405, convert the grid into a matrix, and use the OCR logic to interpret visual information associated with the screenshot 405 in furtherance of analyzing the decrypted screenshot. In this manner, anomaly detection and resolution platform 102 may convert the screenshot into information that may be understood and subsequently used to output an action to resolve the detected anomaly, as discussed at step 215.

Referring back to FIG. 2C, at step 215, anomaly detection and resolution platform 102 may output an action using the AI engine based on the analyzing that was performed at step 214. For example, if the first rule is triggered (e.g., the missing heartbeat), after analyzing the decrypted screenshot, anomaly detection and resolution platform 102 may output a first action that may include generating machine-readable instructions that may be used to re-create an application session that corresponds to a previous session corresponding to an application state associated with the screenshot that user device 106 captured.

As another example, if the second rule is triggered (e.g., the mismatching IP address), then anomaly detection platform 102 may, based on analyzing the screenshot at step 214 and confirming that the session hijacking attempt is legitimate, output a second action that corresponds to blocking and/or disconnecting session control device 107 from user device 106.

As another example, if the third rule is triggered (e.g., an application rendering error), then anomaly detection platform 102 may output a third action that may include identifying and/or sending an alert to the proper team (e.g., a software development team) to take further steps to resolve the error.

In the case in which anomalies may be categorized into different types, then actions may be outputted based on the category of anomaly. For example, a first category may be a failover/site switch category, in which the outputted action may be what is shown and described with reference to steps 216-219. As another example, a second category may be a session hijacking category, in which the outputted action may be what is shown and described with reference to step 220. As another example, a third category may be an application error category, in which the outputted action may be what is shown and described with reference to steps 221-222.

In some instances, anomaly detection and resolution platform 102 might output more than one action based on analyzing the decrypted screenshot at step 214. For example, if the first rule triggered user device 106 to capture a screenshot, and during the analysis of the decrypted screenshot, the AI engine may also determine an application rendering error, the AI engine might output and/or execute the first action and the third action. These and other combinations of actions may be outputted and executed without departing from the scope of the disclosure.

After step 215, either of steps 216-219, step 220, and/or steps 221-222 may be performed based on the action that was outputted at step 215. Although steps 216-219, 220, and 221-222 each describe 3 different examples of actions that may be outputted based on a category that an anomaly is associated with, one or more actions may be outputted without necessarily having the anomalies categorized. The illustrative examples described herein merely show examples which may be implemented without departing from the scope of the disclosure.

Referring to FIG. 2D, specifically steps 216-219, which may generally refer to the case in which the outputted action is based on a failover/site switch (e.g., the first action). At step 216, anomaly detection and resolution platform 102 may generate instructions. For example, in generating the instructions, anomaly detection platform 102 may use the AI engine, specifically based on the analysis performed by the AI engine at step 214, to convert the machine-readable information corresponding to the application state of the application session that user device 106 was accessing, into instructions that may be used to recreate the application session with a different application server (e.g., second application server 105).

At step 217, anomaly detection and resolution platform 102 may send the instructions to second application server 105. For example, anomaly detection and resolution platform 102 may send the instructions to second application server 105 via the private network 101a.

At step 218, second application server 105 may receive the instructions. For example, second application server 105 may receive the instructions from anomaly detection and resolution platform 102 via the private network 101a.

At step 219, second application server 105 may re-create the session using the instructions that were received at step 218. For example, in re-creating the session, second application server 105 may execute the instructions that were sent by anomaly detection and resolution platform 102 in order to establish a new application session that user device 106 may access, without having to take any action with respect to accessing the application via the web browser. In this manner, a seamless transition may be executed from first application server to second application server 105 using the instructions that were generated and sent by anomaly detection and resolution platform 102. After step 219, the sequence may proceed to step 223 and anomaly detection and resolution platform 102 may generate a report.

Step 220 may generally refer to the case in which the outputted action is based on detecting the presence of a session control device (e.g., the second action). At step 220, anomaly detection and resolution platform 102 may disconnect and/or block session control device 107. As such, anomaly detection and resolution platform 102 may disconnect and/or block the hijacker from being able to access user device 106. For example, anomaly detection and resolution platform 102 may disconnect user device 106 from session control device 107 by identifying a connection between user device 106 and session control device 107 and sending commands to user device 106 directing user device 106 to disconnect an established connection between user device 106 and session control device 107. In some instances, anomaly detection and resolution platform 102 may identify an IP address and/or other information identifying session control device 107, in order to block session control device 107 from re-establishing any connection between user device 106 and session control device 107 by sending the IP address/other information to user device 106 so that if session control device 107 tries to re-establish connection again, user device 106 may identify session control device 107 using the corresponding IP address and block any future connection attempts. After step 220, the sequence may proceed to step 223 and anomaly detection and resolution platform 102 may generate a report.

Referring to FIG. 2E, specifically steps 221-222, which may generally refer to the case in which the outputted action is based on an application error (e.g., the third action). At step 221, anomaly detection and resolution platform 102 may identify a team corresponding to the identified error. For example, an application rendering error may be used by anomaly detection and resolution platform 102 to identify a software development team as being the proper team to notify of the error.

At step 222, anomaly detection and resolution platform 102 may send an alert to the team. For example, in the case in which the proper team is a software development team, the alert may indicate to the software development team of the application error (e.g., the application rendering error), which the software development team may use to develop a software update to resolve the error.

After either of steps 216, 219, step 220, or steps 221-222, which each correspond to the type of action that was outputted at step 215, anomaly detection and resolution platform 102 may proceed to step 223 and generate a report.

At step 223, anomaly detection and resolution platform 102 may generate a report. For example, the report may include information such as the anomaly that was detected and/or the action that was outputted to resolve the anomaly. In some instances, the report may be similar to what is shown with respect to FIGS. 5A and/or 5B. For example, and with reference to FIG. 5A, interface 505 may show an indication that the detected anomaly was associated with a failover/site switch, and/or an indication that an action was executed (e.g., what was shown and described with respect to steps 216-219). With reference to FIG. 5B, interface 510 may show an indication that the detected anomaly was associated with a session hijacking attempts and/or an indication that an action was executed by disconnecting the session hijacking device and auto-logging the user out of a corresponding application session. Although not shown, a similar report may be generated and sent based on different anomalies that were detected and corresponding actions that were executed to resolve the anomaly (e.g., detecting an application rendering error and alerting a software development team of the application rendering error).

At step 224, anomaly detection and resolution platform 102 may send the report. For example, in sending the report, anomaly detection and resolution platform 102 may additionally send commands, that when received by enterprise administrative device 108, direct enterprise administrative device 108 to display the report.

At step 225, enterprise administrative device 108 may receive the report and the commands directing enterprise administrative device 108 to display the report.

At step 226, based on or in response to the commands directing the enterprise administrative device 108 to display the report, enterprise administrative device 108 may display the report. For example, the display may be similar to what was shown and described with reference to FIGS. 5A and/or 5B.

At step 227, anomaly detection and resolution platform 102 may dynamically update the AI engine, based on the actions performed in 203-222, and/or based on feedback from any of historical database 103, first application server 104, second application server 105, user device 106, session control device 107, and/or enterprise administrative device 108. In doing so, anomaly detection and resolution platform 102 may dynamically and continuously update (e.g., using a dynamic feedback loop) and/or otherwise refine the AI engine, so as to increase accuracy of the AI engine 112d over time.

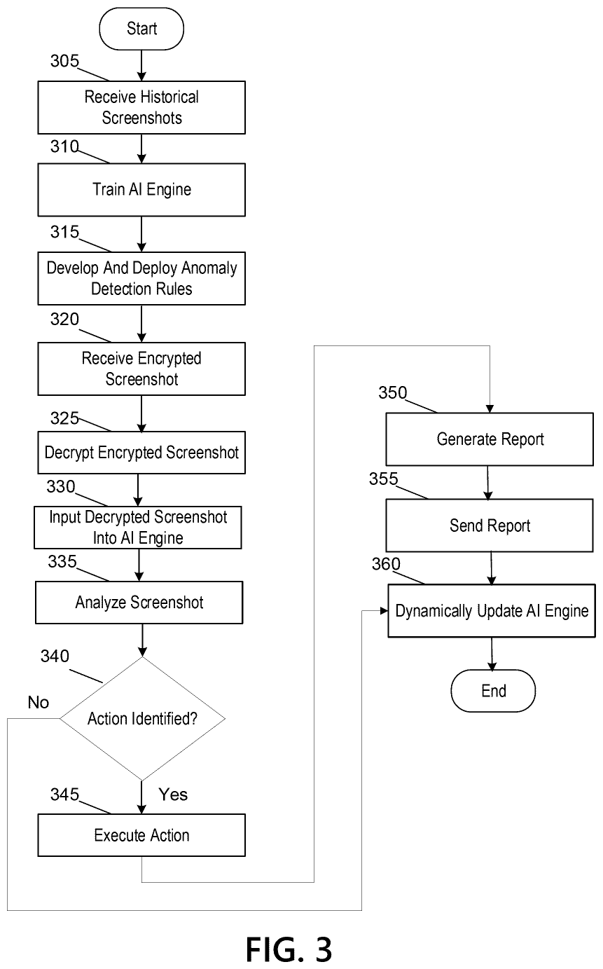

FIG. 3 depicts an illustrative method for detecting and resolving anomalies using AI in accordance with one or more aspects described herein. Referring to FIG. 3, at step 305, a computing platform with at least one processor, a communication interface communicatively coupled to the at least one processor, and memory storing computer-readable instructions may receive one or more historical screenshots. At step 310, the computing platform may use the historical screenshots to train an AI engine.

At step 325, the computing platform may develop and deploy one or more anomaly detection rules to user device 106. At step 315, the computing platform may receive an encrypted screenshot from user device 106, based on or in response to user device 106 triggering one of the anomaly detection rules.

At step 320, the computing platform may decrypt the encrypted screenshot, using for example, encryption module 112c. At step 325, the computing platform may input the decrypted screenshot into the AI engine. At step 330, the computing platform may analyze the screenshot using the AI engine.

At step 335, the computing platform may identify an action to execute based on analyzing the screenshot using the AI engine. If the computing platform identifies an action, the computing platform may proceed to step 340. If the computing platform does not identify an action, the computing platform may proceed to step 360 and dynamically update the AI engine.

At step 340, the computing platform may execute the action that was identified at step 335. For example the action may correspond to either of the actions that were described with reference to steps 216-219, step 220, and/or steps 221-222 of FIG. 2.

At step 345, the computing platform may generate a report. At step 350, the computing platform may send the report to enterprise administrative device 108. At step 355, the computing platform may dynamically update the AI engine.

FIG. 4 depicts an illustrative screenshot for detecting and resolving anomalies using AI in accordance with one or more aspects described herein. For example, screenshot 405 may show URL entry 410, drop down list 420, date entry 430, and hidden icon 440. URL entry 410 may show a website address that may correspond to an application that a user associated with user device 106 may be accessing. Drop down list 420 may be a list of options that a user associated with user device 106 may interactively select, representing, for example, a type of loan a user may be interested in applying for. Date entry 430 may be an entry that a user associated with user device 106 may interactively select in order to input a desired data, associated with, for example, a date in which a user would like to receive a loan. Hidden icon 440 may be an indication not viewable to a user, but machine-readable (by e.g., anomaly detection and resolution platform 102), which may be a way in which the AI engine may detect a session hijacking attempt.

FIGS. 5A-5B depict illustrative graphical user interfaces for detecting and resolving anomalies using AI in accordance with one or more aspects described herein. For example, and with reference to FIG. 5A, interface 505 may show an indication that the detected anomaly was associated with a failover/site switch, and/or an indication that an action was executed (e.g., what was shown and described with respect to steps 216-219). As another example, and with reference to FIG. 5B, interface 510 may show an indication that the detected anomaly was associated with a session hijacking attempts and/or an indication that an action was executed by disconnecting the session hijacking device and auto-logging the user out of a corresponding application session. Although not shown, a similar report may be generated and sent based on different anomalies that were detected and corresponding actions that were executed to resolve the anomaly (e.g., detecting an application rendering error and alerting a software development team of the application rendering error).

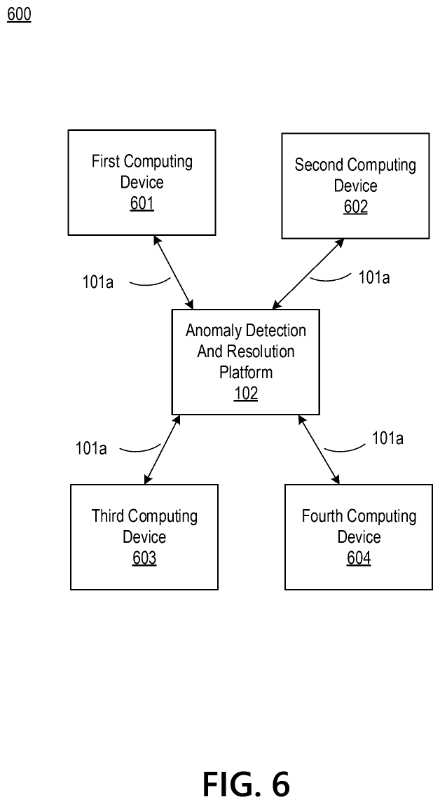

FIG. 6 depicts an illustrative computing environment for implementing a worst-case scenario failover in accordance with one or more aspects described herein. Referring to FIG. 6, computing environment 600 may include one or more computer systems connected through one or more networks. For example, computing environment 600 may include anomaly detection and resolution platform 102, first computing device 601, second computing device 602, third computing device 603, and fourth computing device 604. While the illustration of FIG. 6 includes particular numbers of devices, any number of systems or devices may be used without departing from the aspects described herein.

As mentioned above, computing environment 600 also may include one or more networks, which may interconnect one or more of anomaly detection and resolution platform 102, first computing device 601, second computing device 602, third computing device 603, and fourth computing device 604. For example, computing environment 600 may include private network 101a (similar to the private network that was described with reference to FIG. 1A). In some instances, private network 101a may include one or more sub-networks (e.g., Local Area Networks (LANs), Wide Area Networks (WANs), or the like). In some instances, private network 101a may be associated with a particular user, location (e.g., home, office), and/or organization (e.g., a corporation, financial institution, educational institution, governmental institution, or the like) and may interconnect one or more computing devices associated with the user, location and/or organization.

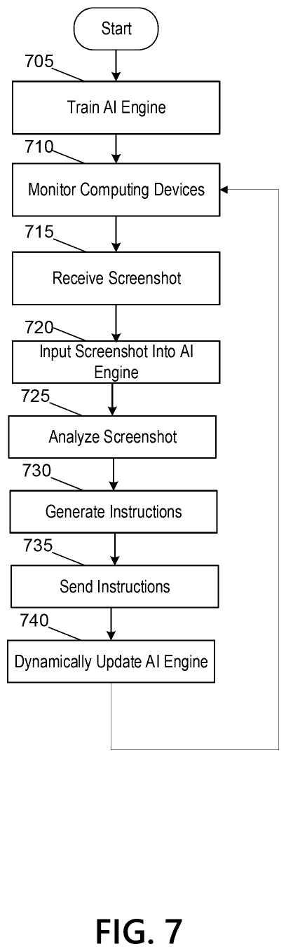

In some instances, the computing environment 600 of FIG. 6 be the same or similar to the computing environment 100 described with reference to FIG. 1A. Additionally or alternatively, the computing environment 600 of FIG. 6 may be an extension and/or a modification of the computing environment 100 of FIG. 1A. As such, the computing environment 600 may describe a different implementation of the functions performed by anomaly detection and resolution platform 102, which are described in more detail with respect to FIG. 7.

Additionally, the discussion surrounding FIGS. 6 and 7 generally described a use case in which a one or more computing devices (e.g., first computing device 601, second computing device 602, third computing device 603, and fourth computing device 604) collectively form a distributed computing environment (within, e.g., a back-end server system or data center), in which each of the one or more computing devices is directed by anomaly detection and resolution platform 102 to perform a sub-portion of a task (such as, e.g., executing an application) across each of the one or more computing devices. In some instances, if one of the computing devices (e.g., first computing device 601) unexpectedly fails, then the task performed by that computing device may fail, and may subsequently trigger a failure across each of the other computing devices performing the other connected tasks.

In a similar manner with respect to the discussion of the functions of the anomaly detection and resolution platform 102 throughout the disclosure, anomaly detection and resolution platform 102, using the AI engine, may monitor the one or more computing devices and, based on identifying a failure at one of the computing devices, may use the AI engine to analyze a screenshot corresponding to a task/session of the failed computing device, generate and send instructions to a different computing device, that may direct the different computing device to re-create the session in order to implement the failed task, as discussed in more detail below.

FIG. 7 is a flowchart illustrating an example method of implementing a worst-case scenario in accordance with one or more aspects described herein. FIG. 7 may describe an example associated with the computing environment 600 of FIG. 6. However, the method described with reference to FIG. 7 may similarly be implemented using one or more of the components described with reference to the computing environment 100 of FIG. 1.

Referring to FIG. 7, at step 705, a computing platform with at least one processor, a communication interface communicatively coupled to the at least one processor, and memory storing computer-readable instructions may train an AI engine. For example, the training may be similar to what was described with reference to step 202 of FIG. 2.

At step 710, the computing platform may monitor one or more computing devices, such as, for example, first computing device 601, second computing device 602, third computing device 603, and/or fourth computing device 604. In monitoring the one or more computing devices, the computing platform may periodically receive information about the one or more computing devices, such as information related to the execution of the task being performed at each of the one or more computing devices.

At step 715, the computing platform may receive a screenshot from one or the computing devices. For example, the computing platform may receive a screenshot from first computing device 601, based on a period of time (e.g., every 15 seconds), and/or based on first computing device 601 identifying an anomaly at the first computing device 601 (similar, e.g., to the anomalies detection rules that were previously described with reference to FIG. 2).

At step 720, the computing platform may input the screenshot into AI engine. At step 725, the computing platform may analyze the screenshot using the AI engine. For example, the computing platform may analyze the screenshot similar to the analyzing that described with reference to FIG. 2 (e.g., step 214).

At step 730, the computing platform may generate instructions based on the analysis of the screenshot at step 725. For example, in generating the instructions, the computing platform may generate machine-readable commands that may be sent to a different computing device to re-create the session/task that was interrupted/failed. For example, if the unexpected task failure occurred at first computing device 601, and the computing platform identifies that second computing device 602 has excess computing resources, then the computing platform may generate and send instructions to second computing device 602 to re-execute the task that first computing device 601 was not able to execute before the unexpected error.

At step 735, the computing platform may send the instructions to a different one of the computing devices than the computing device that sent the screenshot to the platform. For example, the computing platform may send the instructions to second computing device 602 to instruct second computing device 602 to execute the task that was originally intended to be performed at first computing device 601. In this manner, the computing platform may dynamically reallocate tasks that, together, represent an application that is being hosted/task that is being executed by all the computing devices (e.g., first computing device 601, second computing device 602, third computing device 603, and/or fourth computing device 604).

At step 740, the computing platform may dynamically update the AI engine and proceed back to step 710 and continue monitoring the one or more computing devices.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
train, based on historical screenshots, an artificial intelligence (AI) engine, wherein the training configures the AI engine to output an executable action to resolve an anomaly within an application session;
configure one or more anomaly detection rules;
deploy the one or more anomaly detection rules to a user device, wherein deploying the one or more anomaly detection rules configures the user device to enforce the one or more anomaly detection rules locally, and wherein the user device establishes a first application session with a first application server via a web browser;
receive, based on the user device detecting a first anomaly using the one or more anomaly detection rules that were deployed by the computing platform, an encrypted screenshot from the user device;
decrypt the encrypted screenshot;
input the decrypted screenshot into the AI engine;
output, based on analyzing the decrypted screenshot using the AI engine, an action to resolve the first anomaly; and
execute the action, wherein the executing comprises sending commands that resolve the first anomaly.

2. The computing platform of claim 1, wherein the one or more anomaly detection rules further comprise:
a first rule based on the user device detecting a missing heartbeat from an application server that is hosting the first application session that the user device accesses via a web browser;
a second rule based on detecting a different internet protocol (IP) address than an expected IP address; and
a third rule based on detecting an application rendering error.

3. The computing platform of claim 2, wherein the one or more anomaly detection rules are categorized into one or more anomaly categories, and wherein the one or more anomaly categories comprise:
a first anomaly category based on a site switch, wherein the first rule corresponds to the first anomaly category;
a second anomaly category based on a session hijacking attempt, wherein the second rule corresponds to the second anomaly category; and
a third anomaly category based on an application error, wherein the third rule corresponds to the third anomaly category.

4. The computing platform of claim 3, wherein a first action is based on the first anomaly category, and wherein the first action comprises:
generating instructions based on the analyzing the decrypted screenshot using the AI engine; and
sending, to a second application server, the instructions, that when received by a second application server, directs the second application server to re-create the first application session of the first application server.

5. The computing platform of claim 3, wherein a second action is based on the second anomaly category, and wherein the second action comprises:
disconnecting a session hijacking device from the user device; and
blocking an internet protocol (IP) address associated with the session hijacking device to block the session hijacking device from a subsequent connection to the user device.

6. The computing platform of claim 3, wherein a third action is based on the second anomaly category, and wherein the third action comprises:
identifying a proper team to further analyze the first anomaly; and
sending an alert to the proper team.

7. The computing platform of claim 1, wherein the training the AI engine further comprises:
training the AI engine to analyze the historical screenshots using a natural language processing algorithm or an optical character recognition (OCR) algorithm.

8. The computing platform of claim 1, wherein the memory stores additional computer-readable instructions that, when executed by the at least one processor, cause the computing platform to:
update, using a dynamic feedback loop and based on the inputting, the outputting, and the executing, the AI engine.

9. The computing platform of claim 1, wherein the memory stores additional computer-readable instructions that, when executed by the at least one processor, cause the computing platform to:
generate a report, wherein the report comprises the first anomaly and the action that was executed.

10. The computing platform of claim 9, wherein the memory stores additional computer-readable instructions that, when executed by the at least one processor, cause the computing platform to:
send, to an enterprise administrative device, the report and one or more commands directing the enterprise administrative device to display the report, wherein sending the one or more commands directing the enterprise administrative device to display the report causes the enterprise administrative device to display the report.

11. A method comprising:
at a computing platform comprising at least one processor, a communication interface, and memory:
training, based on historical screenshots, an artificial intelligence (AI) engine, wherein the training configures the AI engine to output an executable action to resolve an anomaly within an application session;
configuring one or more anomaly detection rules;
deploying the one or more anomaly detection rules to a user device, wherein deploying the one or more anomaly detection rules configures the user device to enforce the one or more anomaly detection rules locally, and wherein the user device establishes an application session with a first application server via a web browser;
receiving, based on the user device detecting a first anomaly using the one or more anomaly detection rules that were deployed by the computing platform, an encrypted screenshot from the user device;
decrypting the encrypted screenshot;
inputting the decrypted screenshot into the AI engine;
outputting, based on analyzing the decrypted screenshot using the AI engine, an action to resolve the first anomaly; and
executing the action, wherein the executing comprises sending commands that resolve the first anomaly.

12. The method of claim 11, wherein the one or more anomaly detection rules further comprise:
a first rule based on the user device detecting a missing heartbeat from an application server that is hosting a first application session that the user device accesses via a web browser;
a second rule based on detecting a different internet protocol (IP) address than an expected IP address; and
a third rule based on detecting an application rendering error.

13. The method of claim 12, wherein the one or more anomaly detection rules are categorized into one or more anomaly categories, and wherein the one or more anomaly categories comprise:
a first anomaly category based on a site switch, wherein the first rule corresponds to the first anomaly category;
a second anomaly category based on a session hijacking attempt, wherein the second rule corresponds to the second anomaly category; and
a third anomaly category based on an application error, wherein the third rule corresponds to the third anomaly category.

14. The method of claim 13, wherein a first action is based on the first anomaly category, and wherein the first action comprises:
generating instructions based on the analyzing the decrypted screenshot using the AI engine; and
sending, to a second application server, the instructions, that when received by a second application server, directs the second application server to re-create the first application session of the first application server.

15. The method of claim 13, wherein a second action is based on the second anomaly category, and wherein the second action comprises:
disconnecting a session hijacking device from the user device; and
blocking an internet protocol (IP) address associated with the session hijacking device to block the session hijacking device from a subsequent connection to the user device.

16. The method of claim 13, wherein a third action is based on the second anomaly category, and wherein the third action comprises:
identifying a proper team to further analyze the first anomaly; and
sending an alert to the proper team.

17. The method of claim 11, wherein the training the AI engine further comprises:
training the AI engine to analyze the historical screenshots using a natural language processing algorithm or an optical character recognition (OCR) algorithm.

18. The method of claim 11, further comprising:
update, using a dynamic feedback loop and based on the inputting, the outputting, and the executing, the AI engine.

19. The method of claim 11, further comprising:
generating a report, wherein the report comprises the first anomaly and the action that was executed; and
sending, to an enterprise administrative device, the report and one or more commands directing the enterprise administrative device to display the report, wherein sending the one or more commands directing the enterprise administrative device to display the report causes the enterprise administrative device to display the report.

20. One or more non-transitory computer-readable media storing instructions that, when executed by a computing platform comprising at least one processor, a communication interface, and memory, cause the computing platform to:
train, based on historical screenshots, an artificial intelligence (AI) engine, wherein the training configures the AI engine to output an executable action to resolve an anomaly within an application session;
configure one or more anomaly detection rules;
deploy the one or more anomaly detection rules to a user device, wherein deploying the one or more anomaly detection rules configures the user device to enforce the one or more anomaly detection rules locally, and wherein the user device establishes an application session with a first application server via a web browser;
receive, based on the user device detecting a first anomaly using the one or more anomaly detection rules that were deployed by the computing platform, an encrypted screenshot from the user device;
decrypt the encrypted screenshot;
input the decrypted screenshot into the AI engine;
output, based on analyzing the decrypted screenshot using the AI engine, an action to resolve the first anomaly; and
execute the action, wherein the executing comprises sending commands that resolve the first anomaly.
